(19) United States
(12) Patent Application Publication
(10) Pub. No.: US 2021/0392230 A1
(43) Pub. Date: Dec. 16, 2021

(54) SYSTEM AND METHOD FOR INDICATING AND MEASURING RESPONSES IN A MULTI-CHANNEL CONTACT CENTER

(71) Applicant: Avaya Management L.P., Santa Clara, CA (US)

(72) Inventors: Shamik Shah, Pune (IN); Asmita Gokhale, Pune (IN); Valentine C. Matula, Granville, OH (US)

(21) Appl. No.: 16/899,396

(22) Filed: Jun. 11, 2020

(51) Int. Cl. H04M 3/523; H04M 3/51

(52) U.S. Cl. CPC H04M 3/523; H04M 3/5166; H04M 3/5183; H04M 3/5175

(57) ABSTRACT

Agents, whether human agents or automated agents, may be provided with content to deliver to a customer during a communication. The content may have an emotional content, as well as a factual content, that may be appropriate or inappropriate for a particular communication with a customer. Agents may be prompted to provide the content and the emotional content but whether they do or not is not always certain. By determining a difference between actual emotional content and an expected emotional content and executing steps to correct such differences, communications that comprise emotional content outside of nominal range may be corrected, within the communication and/or in subsequent communications. Additionally, long-term trends for one or a plurality of agents may be identified and managed as appropriate.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for message insertion and directing and, more particularly, to presenting single node signals to direct a dual-node communication.

### BACKGROUND

In most industries, handling customers' needs through communication channels are of prime importance. Communications may comprise a human or automated agent communicating with customers via voice, voice and video, short message service (SMS)/text, chat, and emails, for the majority of communication modes. Agents, whether human or automated, can be provided with scripts or other prompts to provide the customer with the information necessary to resolve the purpose for the communication. Fully configured automated agents will deliver the exact message, and in the exact way, as programmed. However, automated agents, that comprise artificial intelligence (AI) and self-learn and may rely on a learning phase to self-program or configure the tone for any one or more messages. This initial coarse guidance may result in message tone's varying between extremes until sufficient feedback is observed and the target tone becomes known with more granularity. Human agents may also provide the incorrect tone for a particular message. This may be due to training or prompting issues or the agent may make the determination that a deviation from the specified tone is warranted; such a determination may or may not be correct.

### SUMMARY

In any industry, handling customers through automated emails, chat operations are of prime importance. In a multichannel (e.g., voice, chat/messaging, emails, video, etc.) contact center voice communications, as well as short message service (SMS), text, chat, social media post/reply, email, and other text-based communications are similarly of key importance to address customer issues, receive and process customer requests, and other communications. Customers are often connected to an automated resource to provide automated emails, SMS/text, and/or live chat via chatbots are used to respond to customers efficiently to answer questions, seek information, provide options or suggestions, or otherwise address an issue for customers.

A problem with many automated SMS, email, and chatbot replies or other statements/question asked by chatbots, is that they do not include “human touch,” for example emotions, with which a particular situation with a customer is required to be handled properly. Due to the lack of emotions, automated messages handle the customer, even different types of customer, in the same way. The absence of an appropriate emotional tone may lead to customer dissatisfaction or resentment.

As an example, a frustrated customer is complaining about the service disruptions or poor product quality during a live chat or via email. The usual chatbot or email replies would provide emotionless answers and suggested courses of action but would not sufficiently handle the customer who may have a need to know that their concerns, and their business, are important and/or the source of their frustration sufficiently appreciated. A factual, emotionless response may increase the customer's frustration as the customer is left to the mercy of emotionless automated replies.

In a different scenario, consider a marketing or sales campaign to be carried across different regions of the world. Asian, African, Arab, central European and Latin American cultures are generally considered to be high-context cultures, that is they rely on implicit communication and nonverbal cues. Whereas cultures with western European roots, such as the United States and Australia, are generally considered to be low-context cultures which relies on explicit communication. If the same, preconfigured automated replies or chat replies are used to campaign or respond across the world it would not be well received and the communications wasted, which may require a follow-up or other communication.

The determination of the emotion to apply may be based on one or more of:

1. Customer information, personality type of the customer

2. Real time analysis of the context of the conversation

3. Text analysis of emails or chats to understand the emotion of the customer e.g. angry, happy, dissatisfied, frustrated, depressed, etc.

4. Past history of type of interaction with the customer e.g. successful, unsuccessful, satisfied, dissatisfied, etc.

5. Past history of problem/issue/requirement of the customer.

6. Current ongoing latest, highest and average issues/requirements in the contact center overall and their resolutions

7. Dictionary of words

8. Geographic region customer belongs to

9. Culture and religion of the customer

10. Origin and current location of the customer

11. Demographic details of the customer

12. Kind of problem mapped to the personality type of the customer and its demographics.

The foregoing list of factors is not exclusive and other factors to the emotion determination process may also be considered.

For example, emails or chat responses can be altered considering the culture of a particular customer. If a customer belongs to, for example, an Asian culture which is considered to be high-context culture email or chat replies can be changed to use high-context language in the responses. In high-context cultures such as this, a message is more difficult to understand without a background information, which may be significant. For example, the background may include detailed greetings, talks about past conversations, etc. However, communications with customers that belong to a low-context culture, such as those with western European roots, are more likely to be successful if direct, to-the-point, responses are used in email or chat responses.

Understanding the severity of the issue can be of high importance. However different customers may perceive different issues with different severity. As a yet another example, service disruptions are considered to be critical issues for businesses but not for households. Therefore the responses from email or chatbots may be tweaked accordingly for the kind of issue mapped to the kind of customer in addition or alternative to the factors disclosed herein.

A configurable indicia, which may include color, font, metadata, etc., may be applied to highlight the sentences where-in a particular indicia would emphasize a specific emotion while delivering that sentence. Individual words can also be highlighted or emphasized differently describing the amount of emphasis required on that word. While choosing the colors geographic aspects can also be considered and accordingly email or chat responses can be modified. For example, red color is considered sign of risk in most of the countries but in countries like for example China red is considered as symbol of luck, prosperity, happiness.

These methods help in impersonating the automated emails or chat responses as to be originating from a human and not machine, which will further raise the satisfaction level of the customer that they are being provided personal attention.

Choosing the correct word, from a pool of equivalent individual words or phrases, is made based on the determined context at hand as well as the customer's personality and emotions. For example, when the customer's sentiments are negative the selection of words to be replied may be selected to be more submissive and affirmative.

Implementation of the embodiments herein promote the acceptability rate of the responses delivered to the customer. The right choice of sentences, with emphasis on the impactful words with proper reflective emotions would make the conversation more satisfactory and efficient. As the acceptability rate increases, time required to close down on a conversation reduces leading to high customer satisfaction.

Embodiments disclosed herein emphasize the modification of automated email, chat, or other text messages provided by automated agents to adapt to the customer being handled and the context of the conversation. Different personality type of customers with same or different emotions, from same or different origins, cultures and religions, with same or different problem/requirement at hand, will receive personalized, effective and efficient responses as we are mining the customer's emotions, conversation context, demographic details, countries and cultures and adapting to it. Therefore, the current embodiments help to achieve higher customer satisfaction in less time, more effectively, and this is helpful across all the industries.

Agents may be provided with real-time cues, such as scripts or prompts. However, the prior art failed to consider the human touch, e.g., emotions, with which an agent should handle a particular customer. Due to the lack of emotions, agents tend to treat different types of customers based on the agent's own personality and their own unique way of handling the customers. Therefore, despite having relevant real-time prompts to the agents, the entire conversation may not turn out to be very effective, which may cause customer dissatisfaction or resentment. On the other hand, a highly skilled and experienced agent would handle the same customer with reflective emotions leading to higher levels of customer satisfaction and positive takeaways.

As an example, a frustrated customer is complaining about a service disruptions or poor product quality. The usual real-time scripting and prompts to the agents would never be sufficient to handle such a customer. An inexperienced agent or an agent with contradicting personality, would likely make the situation worse as the customer is only left to the mercy of emotionless agent scripts and real time conversation based prompts.

In another example, such as during a marketing or sales campaign, an agent encounters a tough customer. The agent would offer the best deals to the customer, but in what manner? The “manner” here would correspond to the agent's own personality and the agent's own unique way of handling the customer. The real-time agent scripts would only enable agents to know “what” to speak but not “how” to say.

Agent of a contact center are variously embodied. In one embodiment, an agent is a human agent that is capable of deviating from a prescribed script or prompt to provide to a customer during an electronic communication with the customer over a network and utilizing communication devices. In another embodiment, an agent is an automated agent requiring a “learning” phase in order to self-program or self-configure in order to deliver a script to a customer, via the network, in an appropriate tone, and the learning phase, for embodiments herein, is not complete. As a result, an agent, human or automated, may be prompted to provide a message (e.g., human-spoken script, machine-generated speech from a script, etc.) having a previously determined tone. The tone may be selected for a particular communication and/or particular customer or a category thereof.

These and other needs are addressed by the various embodiments and configurations of the present invention. The present invention can provide a number of advantages depending on the particular configuration. These and other advantages will be apparent from the disclosure of the invention(s) contained herein.

In one embodiment, an agent is measured and evaluated relative to a previously determined desired emotional tone, or level of such a tone, such as may be specified in a coaching. Accordingly, differences between actual and expected responses and behaviors may be identified and measured. The results of the differences may be displayed or otherwise indicated back to the agent, or other party (e.g., supervisor, human resources, etc.) of the contact center, in real time and/or as a historic value. Sending the differential score to the supervisors, thereby enabling the supervisors to take various actions, such as, to drive escalations, identify agents that need training, or that are proficient and can become trainers/role models.

Providing hints or cues, in particular real-time hints or cues, to the agent, may better identify whether the content and/or the emotional level of message needs to be changed and allow the agent to readily implement those changes. Additionally or alternatively, long-term (hourly, daily, weekly, etc.) difference scores provides historic trends to indicate to agents and/or others, if the agent is getting closer to targets over time or drifting away.

The factors to be measured regarding the content and/or emotion of the delivered responses, include, but are not limited to, one or more of:

1. Speech to text conversion of the real-time audio in case of voice responses;

2. Facial expression analysis in case of a video or a web conference call/assist;

3. Real time analysis of the context of the entire conversation;

4. Text analysis of emails or chats to understand the emotion of the customer (e.g. angry, happy, dissatisfied, frustrated, depressed, etc.); and

5. Real-time voice and tone analysis of the ongoing conversation.

The foregoing factors, as used herein, when utilized as the factors of the actual response are denoted as ‘f(y)’ hereinafter, and the score generated out of the factors as ‘y’. For real-time communication modes (e.g., voice, voice and video, etc.) the factors may vary during the communication. However, for text-based communication modes (e.g., SMS, email, chat, etc.) the factors may be constant for at least the duration of a communication and optionally longer, such as until a concern is received or a response is sent on the same conversation providing feedback or other information regarding a tone that was perceived as inappropriate or needing improvement.

Factors considered in generating a personalized response include, but are not limited to, one or more of:

1. Customer information (e.g., personality type of the customer);

2. Real time analysis of the context of the conversation;

3. Text analysis of emails or chats to understand the emotion of the customer (e.g. angry, happy, dissatisfied, frustrated, depressed, etc.);

4. Past history of type of interaction with the customer (e.g. successful, unsuccessful, satisfied, dissatisfied, etc.);

5. Past history of problems, issues, and/or requirements of the customer;

6. Current ongoing latest, highest and average issues/requirements in the contact center overall and their resolutions;

7. Dictionary of words;

8. Geographic region that customer belongs to;

9. Culture and religion of the customer;

10. Origin and current location of the customer;

11. Demographic details of the customer;

12. Kind of problem mapped to the personality type of the customer and its demographics; and/or

13. Past history of the voice and tone analysis of the same or similar personality type of customer having same or similar problem/issue.

The immediately preceding factors, as used herein, are utilized as the factors of the expected response and are further denoted as ‘f(x)’ hereinafter, and the score generated out of the factors as ‘x’. Certain of these expected response factors are variable while others, notably 1, 4, 5, 7, 8, 9, 10, 11, 13 can be considered as constants as they will not change during the course of a communication.

Based on the expected and the actual scores x and y, a difference or delta can be calculated (see Formula 1), with the delta referred to as ‘z’ hereinafter:

z=x−y (Formula 1)

The factors of z are:

f(z)=f(x)−f(y) (Formula 2)

except for constant factors of x that do not change in real time.

It should be appreciated that values of z may be positive, negative, or zero. In on embodiment, the value z may be referred to as a distance from the expected response, in other words an absolute value with, or without, an indication of direction towards the positive or negative. Therefore, a value of zero or within a previously determined nominal range from zero is considered to be on-target and values outside of the previously determined range are considered off-target.

In another embodiment, negative values for z result from an actual response having a value that is greater than the expected response, and may be considered to indicate a response that is better than expected (e.g., scripted, prompted), which may further be input into prompting human agents and/or training machine learning algorithms. Conversely, when z is a positive value when the actual response is less than the expected response, the response provided may be determined to be deficient from the expected response, such as may indicate that the response needs to be improved with respect to the content and/or emotionally. It should be appreciated that alternate mathematical operations and/or value sets may be utilized to determine a difference between an actual response and an expected response and optionally the direction of the difference (i.e., greater than versus less than), without departing from the scope of the embodiments provided herein.

For example, if customer belongs to an Asian culture that is high context culture, the customer may expect more details during the conversation. Hence, a system implementing certain embodiments herein, will indicate the expected response f(x) to be more detailed. If the agent handling such a customer belongs to low context culture, the agent may not deliver the response using high context language, such as may be unfamiliar or uncomfortable considering the agent's own personality trait or cultural background. Accordingly, the actual delivered response f(y) may deviate from expected response and hence z will be positive.

With the score (‘z’) determined, the score may be provided to the agent in real-time. This may be particularly relevant if the score is positive. In case of automated agents, the score may be provided as an input into the machine learning algorithms to improve the next response. For example, the algorithm may select a particular response and, based on a resulting score, weight the particular response accordingly so that it will, or will not, occur again or will occur more, or less, frequently, as indicated by z being positive or negative, respectively.

The raw score or indication of the score may be presented to a human agent, in real-time and/or after one or more communications, such as by:
Display the score z as a number indicating positive and negative value.
Display the score z as a number with status-indicating colors (e.g., green for a better response than expected, white for as-expected, red for worse than expected or positive scores, etc.). Intermediate colors and shades can also be used to indicate the accepted values even if the score is positive (e.g., orange or yellow before moving to red).
Display the score z as a status-indicating color bar that would change in real time. Different colors can be used to indicate the distance of the actual response sent or being sent to the expected response (e.g., from positive to negative, the colors would be red, pink, orange, yellow, white, green, bright green, etc.).
Display the score z as a combination of bar as well as number with different colors as described above.
Display the score as status-indicating emoticon, symbol, or other graphic, such as a speedometer.
Display the average of hourly, weekly, monthly scores to indicate whether they have improved over the course of time.

These indicators will help agent know in real time and/or over time whether their responses are meeting the expected response.

In another embodiment, the factors of ‘z’, that is ‘f(z)’, are determined and presented to provide indicia of specific improvements opportunities as differences between the individual factors f(x) and f(y), and thereby identify specific elements where the agent is falling short to match the expected response or doing exceptionally well. For automated agents, these differences may be input into the machine algorithms for improving the automated responses. While real-time indications of performance at or above expectations may be helpful in some circumstances, real-time indications of deficient performance are generally more relevant, as a different action should be implemented. Upon analyzing a shortfall, the representation of which may be displayed to the agent in one or more of the following indicators:
Display the factor as-is (e.g., change a sentence to be more affirmative).
Display a direct hint (e.g., change the word “impact” to “influence,” so that the sentence becomes more positive/affirmative).
Color code the words or sentences that do not match the expected emotional level

The score is also helpful to the supervisors as well as the organization in measuring the performance of the agents as well as finding which agents would need more training and also what kind of training. Additionally or alternatively, personnel such as supervisors may set a configurable parameter (e.g., content score, emotional score, content plus emotional score, etc.), as well as an acceptable threshold, which may be calculated (see Formula 3) as an acceptable score for an agent(s) as alpha, herein “A”:

A=x+Threshold (Formula 3)

wherein “x” is an expected score, as described above.

In another embodiment, if an agent is determined to exceed alpha value “A”, then a response may be performed, comprising actions including, but not limited to, one or more of: Blocking the response; Escalating the response to a reviewer/supervisor, and/or executing an escalation (e.g., attach another agent to a call to provide “whisper” communications to the agent, attach another agent to the call to provide content to both the agent and customer, transferring the communication to another agent, transferring the communication to a different mode of communication, etc.), such as in response an agent taking a greater number of calls, or more time in the same call, to adapt to the required score.

As a benefit of the embodiments provided herein, a previously determined level of content and emotional tone, such as for a particular customer and/or circumstance, may be consistently provided across all agents, including agents that may have a different background or perception of how a customer should be handled. As a further option, system-wide standards may be managed, such as to have a campaign to meet or exceed a previous overall score.

In one embodiment, the factors described herein may be of equal weight. In another embodiment, differential weighting may be provided for one or more factors, such that values x and y can be calculated (see Formulas 4-5) based on either all the factors equally or weighted:

x=w₁f₁+w₂f₂+w₃f₃+ . . . +wₙfₙ (Formula 4)

or, as rewritten as:

x=Σₖ₌₁ⁿwₖfₖ (Formula 5)

In another embodiment, the standard deviation Beta, (“B” herein), is calculated (see, Formula. 6):

$$B = \sqrt{\frac{{Σ ( {z}_{n} )}^{2}}{{N}_{c}}} \qquad ( Formula 6 )$$

where x=expected score of individual call or response;

y=actual score of each response in a conversation;

z=x−y;

Nc=the total number of calls handled by the agent while working on Campaign c; and

Zn=the total of z of all the calls on Campaign c.

In another embodiment the Beta value “B” is displayed in real time to the supervisors on the real time dashboard calculated differently for a particular agent, cumulative for all the agents, a particular campaign, and/or cumulative for all the campaigns.

Benefits of the embodiments disclosed herein include, but are not limited to: Measuring the responses in real time; Display the measurement to the agents in real time as an indicator of expected and actual response/behavior; Provide hint to the agents as to what needs to be improved; Enable supervisors to configure campaigns to set an acceptable level of content, in combination with emotion, that should be proved to the customer(s); Enable supervisors to view the standard deviation in various forms in real time; Enable supervisors to measure the performance of agents and their adaptability based on several factors; Enable supervisors to identify key training/coaching areas for the agents; and Enable organizations to set standards for treating their customers.

Various embodiments and aspects of the embodiments are disclosed, including:
In one embodiment, a method for responding to a non-compliant action is disclosed, comprising: monitoring content of a communication between an agent communication device utilized by an agent and a customer communication device utilized by a customer, respectively; analyzing the content for emotion to produce an actual emotional content; accessing an expected emotional content associated with the communication; producing a score as the difference between the target emotional content and the observed emotional content; formatting a message to comprise the score; and transmitting the message in real time to at least one device, selected from the agent communication device and an administrative communication device, to cause the at least one device to have immediate access to the score.
In another embodiment, a system for responding to a non-compliant action is disclosed, comprising: a processor coupled to a non-transitory memory comprising executable instructions; a network interface coupled to the processor; and wherein the instructions cause the processor to: monitor content of a communication between an agent communication device utilized by an agent and a customer communication device utilized by a customer, respectively; analyze the content for emotion to produce an actual emotional content; access an expected emotional content associated with the communication; produce a score as the difference between the target emotional content and the observed emotional content; format a message to comprise the score; and transmit the message in real time to at least one device, selected from the agent communication device and an administrative communication device, to cause the at least one device to have immediate access to the score.
In another embodiment, a system for responding to a non-compliant action is disclosed, comprising: means to monitor content of a communication between an agent communication device utilized by an agent and a customer communication device utilized by a customer, respectively; means to analyze the content for emotion to produce an actual emotional content; means to access an expected emotional content associated with the communication; means to produce a score as the difference between the target emotional content and the observed emotional content; means to format a message to comprise the score; and means to transmit the message in real time to at least one device, selected from the agent communication device and an administrative communication device, to cause the at least one device to have immediate access to the score.
Aspects of one or more of the embodiments include wherein the formatting of the message to comprise the score and the transmitting of the message in real time to the at least one device, are performed upon determining the score is outside a nominal range.
Aspects of one or more of the embodiments include: adding the score to a data structure maintained in a data storage device; deriving, from the data structure, an aggregate score for a plurality of scores, comprising the score, for at least one of (i) an associated first plurality of communications each of which comprises content provided by the agent or (ii) an associated second plurality of communications each of which comprises content provided by a plurality of agents, comprising the agent; formatting an aggregate score message to comprise the aggregate score; and transmitting the aggregate score message in real time to the at least one device to cause the at least one device to have immediate access to the aggregate score.
Aspects of one or more of the embodiments include formatting the message comprising the score, further comprises, formatting the message to comprise the score and at least one secondary indicia of the magnitude of the score; and transmitting the message in real time to the at least one device, selected from the agent communication device and the administrative communication device, to cause the at least one device to have immediate access to the score and the secondary indicia of the magnitude of the score.
Aspects of one or more of the embodiments include, wherein the score comprises at least one score factor, as the difference between a target factor for the content and the observed factor, and comprising a value for one or more of word selection from a pool of words that differ in emotional association, phrase selection from a pool of phrases that differ in emotional association facial expression, punctuation selection from a pool of punctuations that differ in emotional association, graphic selection from a pool of graphics that differ in emotional association, body posture, gesture, paralinguistic, eye gaze, and delivery timing of messages comprising the communication.
Aspects of one or more of the embodiments include, wherein formatting the message to comprise the score, further comprises formatting the message to comprise indicia of the score.
Aspects of one or more of the embodiments include, wherein the communication comprises a text-based communication message maintained in the agent communication device as a draft and wherein the transmitting of the message is pending.
Aspects of one or more of the embodiments include, wherein: the agent comprises an automated agent selecting content from a data storage comprising a plurality of content and each having a weighting value determining, in part, a past score as the difference between the target emotional content and the observed emotional content of a past communication comprising each of the plurality of content; and the selection of the content comprises a pseudo-random weighted selection from the plurality of content.
Aspects of one or more of the embodiments include updating the past score to comprise the score for the content selected.
Aspects of one or more of the embodiments include, wherein the instructions further cause the processor to format the message to comprise the score and the transmitting of the message in real time to the at least one device, are performed following executing instructions to cause the processor to determine the score is outside a nominal range.
Aspects of one or more of the embodiments include, wherein the instructions further cause the processor to: add the score to a data structure maintained in a non-transitory data storage device; derive, from the data structure, an aggregate score for a plurality of scores, comprising the score, for at least one of (i) an associated first plurality of communications each of which comprises content provided by the agent or (ii) an associated second plurality of communications each of which comprises content provided by a plurality of agents, comprising the agent; format an aggregate score message to comprise the aggregate score; and transmit the aggregate score message in real time to the at least one device to cause the at least one device to have immediate access to the aggregate score.
Aspects of one or more of the embodiments include, wherein the instructions further cause the processor to: format the message comprising the score, further comprise instructions to cause the processor to format the message to comprise the score and at least one secondary indicia of the magnitude of the score; and transmit the message in real time to the at least one device, to cause the at least one device to have immediate access to the score and the secondary indicia of the magnitude of the score.
Aspects of one or more of the embodiments include, wherein the score comprises at least one score factor, as the difference between a target factor for the content and the observed factor, and comprising a value for one or more of word selection from a pool of words that differ in emotional association, phrase selection from a pool of phrases that differ in emotional association facial expression, punctuation selection from a pool of punctuations that differ in emotional association, graphic selection from a pool of graphics that differ in emotional association, body posture, gesture, paralinguistic, eye gaze, and delivery timing of messages comprising the communication.
Aspects of one or more of the embodiments include, wherein the instructions that cause the processor to format the message to comprise the score, further comprise instructions to cause the processor to format the message to comprise indicia of the score.
Aspects of one or more of the embodiments include, wherein the communication comprises a text-based communication message maintained in the agent communication device as a draft and wherein the instructions to cause the processor to transmit the message have not been executed.
Aspects of one or more of the embodiments include, wherein: the agent comprises an automated agent selecting content from a data storage comprising a plurality of content and each having a weighting value determining, in part, a past score as the difference between the target emotional content and the observed emotional content of a past communication comprising each of the plurality of content; and wherein the instructions to cause the processor to select the content further comprises instructions to cause the processor to make a pseudo-random weighted selection from the plurality of content.
Aspects of one or more of the embodiments include, wherein the instructions further comprise instructions to cause the processor to update the past score to comprise the score for the content selected.
Aspects of one or more of the embodiments include means to determine whether the score is outside a nominal range; and means to omit the means to format the message to comprise the score and the means to transmit the message in real time to the at least one device, when the score is within the nominal range.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts a third system in accordance with embodiments of the present disclosure;

FIG. 4 depicts a first data structure in accordance with embodiments of the present disclosure;

FIG. 5 depicts a transition of data in accordance with embodiments of the present disclosure;

FIG. 6 depicts a first display in accordance with embodiments of the present disclosure;

FIG. 7 depicts a second display in accordance with embodiments of the present disclosure;

FIG. 8 depicts a process in accordance with embodiments of the present disclosure; and

FIG. 9 depicts a fourth system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

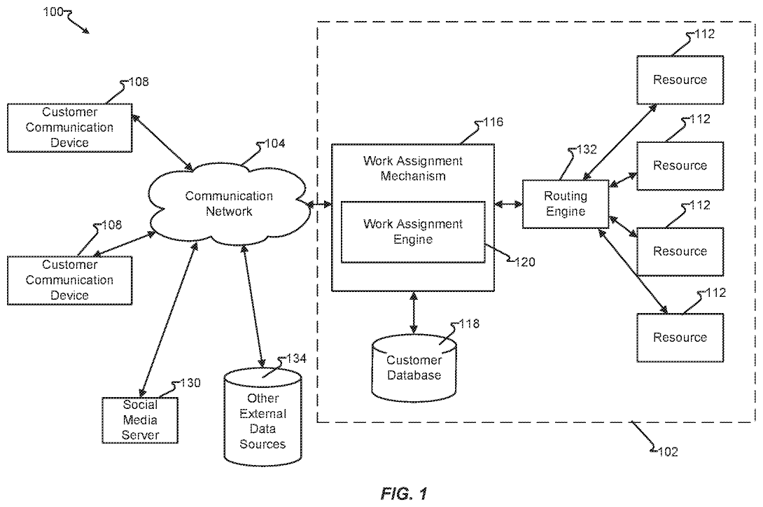

With reference now to FIG. 1, communication system 100 is discussed in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are or are associated with work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., company, enterprise, etc.), and/or logical boundary (e.g., resources 112 utilized to provide services to customers for a customer of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other component may connect to routing engine 132 via communication network 104, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134 may be within contact center 102 physically and/or logically, but still be considered external for other purposes. For example, contact center 102 may operate social media server 130 (e.g., a website operable to receive user messages from customers and/or resources 112) as one means to interact with customers via their customer communication device 108.

Customer communication devices 108 are embodied as external to contact center 102 as they are under the more direct control of their respective user or customer. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media server 130 and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type and instead may be comprised of a number of different networks and/or network types. As one example, embodiments of the present disclosure may be utilized to increase the efficiency of a grid-based contact center 102. Examples of a grid-based contact center 102 are more fully described in U.S. Patent Publication No. 2010/0296417 to Steiner, the entire contents of which are hereby incorporated herein by reference. Moreover, the communication network 104 may comprise a number of different communication media, such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item. Illustrative work items include, but are not limited to, a contact directed toward and received at a contact center 102, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media server 130 or network of servers. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively; each of which is hereby incorporated herein by reference in its entirety.

The format of the work item may depend upon the capabilities of the communication device 108 and the format of the communication. In particular, work items are logical representations within a contact center 102 of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication. At which point, the work assignment mechanism 116 passes the work item to a routing engine 132 to connect the communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general, each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, microprocessors, servers, or the like), human resources utilizing communication devices (e.g., human agents utilizing a computer, telephone, laptop, etc. or other agent communication device), or any other resource known to be used in contact center 102.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more hardware components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

It should be appreciated that one or more components of contact center 102 may be implemented in a cloud-based architecture in their entirety, or components thereof (e.g., hybrid), in addition to embodiments being entirely on-premises. In one embodiment, customer communication device 108 is connected to one of resources 112 via components entirely hosted by a cloud-based service provider, wherein processing and data storage hardware components may be dedicated to the operator of contact center 102 or shared or distributed amongst a plurality of service provider customers, one being contact center 102.

In one embodiment, a message is generated by customer communication device 108 and received, via communication network 104, at work assignment mechanism 116. The message received by a contact center 102, such as at the work assignment mechanism 116, is generally, and herein, referred to as a “contact.” Routing engine 132 routes the contact to at least one of resources 112 for processing.

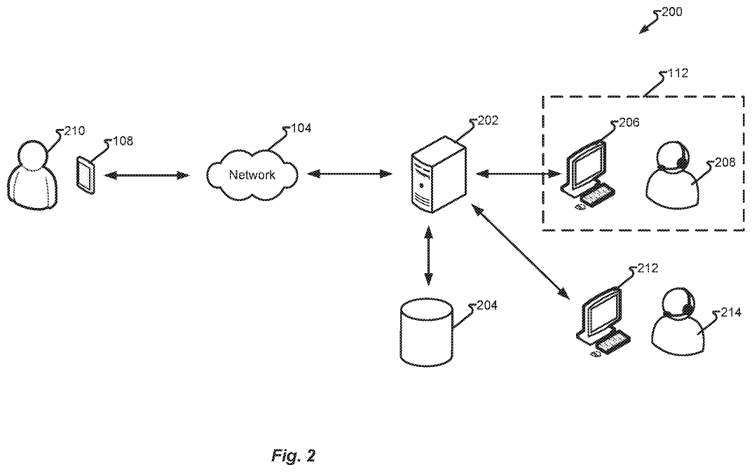

FIG. 2 depicts system 200 in accordance with embodiments of the present disclosure. In one embodiment, resource 112 is embodied as agent communication device 206 utilized by human agent 208 to communicate with customer 210 via customer communication device 108 over communication network 104. Server 202 is illustrated as an intermediary device between resource 112 and communication network 104 and may include features and functionality such as switch, hub, router, etc. to facilitate the communication between customer communication device 108 and resource 112. In another embodiment, server 202 monitors the content of the communication between agent communication device 206 and customer communication device 108 and optionally includes or omits switching, routing, or other connectivity or connectivity management operations.

In another embodiment, server 202 monitors the content of the communication between agent communication device 206 and customer communication device 108, which may be encoded for transmission on communication network 104. Human communications are complex and often nuanced. A message or meaning may be explicitly conveyed in text or spoken words, additional meanings, even contradictory meanings, may be conveyed in other ways, such as an emotional tone (e.g., empath, impatient, authoritativeness, etc.) conveyed in a subtext of meaning provided by a particular selection of words or combination of words or non-textual/non-verbal vocalizations (e.g., pitch, pace, sighs, etc.). For example, a textual message that says: “Reboot your computer now and tell me when it has restarted.” conveys the same express meaning (instructions to reboot a computer and indicate when the computer has restarted) as the text: “Sorry, but you will need to reboot your computer. Please let me know when your back up and running.” but there is clear difference in the emotional tone. Here, the first example is cold, unfeeling, unsympathetic, authoritative, machine-like, etc. The second is sympathetic, relatable, human-like, etc.

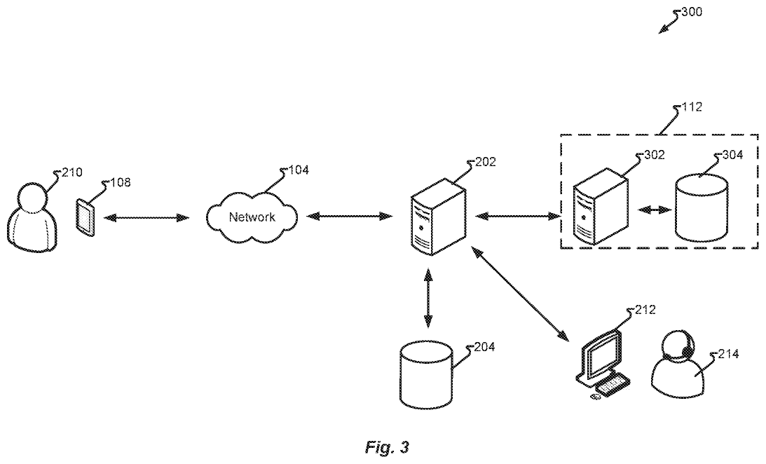

For text-based communications (e.g., SMS, chat, email, etc.) humans can perceive alphanumeric characters (e.g., letters, numbers, symbols, punctuations, etc.), graphical elements (e.g., emoticons), that are expressly represented on a display, such as a display of customer communication device 108, as well as the paralinguistics (e.g., emotional tone, attitude, etc.) that is encoded into the specific text via word choice, punctuations, etc. Similarly, for voice-based communications (e.g., audio telephone call, audio chat, etc.) human speech provided by human agent 208 may convey similar paralinguistics in the tone, loudness, inflection, pitch, pace, etc., of the speech. For visual communications (e.g., video chat), facial expressions, gestures, eye gaze, use of artifacts (e.g., fiddling with a pen, note taking, etc.), may convey meanings outside the literal meaning of any words provided. Accordingly, as used herein, “content” or “content of the communication” refers to the human-perceivable portions of a communication, sent by human agent 208 (or automated agent 302, see FIG. 3) and specifically intended to be presented to the human (e.g., customer 210) when the content is provided to customer communication device 108, for presentation by an output component (e.g., textual display, graphical display, video display, speaker, etc.) of communication device 108. Content may include, but is not limited to, words and phrases and the explicit and/or implicit meanings of the words or phrases, punctuations, symbols, graphics; images comprising gestures, expressions, etc.; and/or paralinguistics of words or phrases.

It should also be appreciated that “content” or “content of the communication,” as used herein, does not include data conveyed to initiate, support, or maintain the communication, such as, headers, codecs, encryption, call setup/takedown messages, quality of service (QoS) monitoring data, and other data that may include or be included in a communication that is not expressly intended for presentation to customer 210 as a portion of the communication between customer 210 and human agent 208 (or automated agent 302).

Human agent 208 may be provided with prompts on the words to provide during a communication and optionally the emotional tone provided by a particular word choice, phrasing, images (when the communication comprises video), or paralinguistics (when the communication comprises audio). Human agent 208 may improvise or otherwise alter the content and, in doing so, alter the emotional tone of the communication. Server 202 may quantify the emotional content the portion of the communication provided by human agent 208 and, if not already provided, quantify the emotional content of the prompted words provided to human agent 208. A difference, or score, between the actual and expected emotional content is then determined.

The score may be maintained in data storage 204 or other non-transitory data storage. Data storage 204 may also be utilized by a processor of server 202, agent communication device 206, and/or administrative communication device 212 to maintain accessible data (e.g., machine-readable instructions, data records, etc.). Additionally or alternatively, scores having a value outside an acceptable nominal range may trigger additionally processes. For example, feedback, in real time and/or after the communication has concluded, may be provided to human agent 208, such as via agent communication device 206, to provide human agent 208 with metrics on their performance is delivered versus as expected. In a further embodiment, exceptional scores, may be flagged or otherwise emphasized as an area requiring improvement, or an example of a practice to be adopted in the future, when negative. Scores may be provided to administrative communication device 212 for presentation to administrative agent 214 (e.g., supervisor, human resources, etc.) as a historic record of the performance of human agent 208. However, in certain circumstances, real time action may be warranted. Accordingly, in another embodiment, server 202 may determine that a score, or a factor of the score, is outside an acceptable nominal range and, in response, format a message comprising the score (e.g., “score=3.8”, “empathy=4.4,” “authoritative=6.3”) and/or indicia of the score (e.g., “problem,” “unacceptable content,” “action required,” “agent is exceptionally aggressive,” “agent said, ‘do what I tell you.” etc.) or other standardized format, for immediate transmission to administrative communication device 212, such as to alert administrative agent 214, and or other systems and components, of a situation requiring action in real time and in a standardized format.

Actions that may be taken to address a score outside an acceptable nominal range include, automatically joining another node (e.g., administrative communication device 212) to the communication between customer communication device 108 and agent communication device 206 in either “whisper” mode; such that all communications between customer 210 and human agent 208 and presented to administrative communication device 212 but any communication provided by administrative communication device 212, such as those originating from administrative agent 214, may only be received by agent communication device 206 for presentation to human agent 208; or fully joined as a three-way communication comprising each of the nodes customer communication device 108, agent communication device 206, and administrative communication device 212. As further embodiment, agent communication device 206 may be disconnected from the communication entirely (i.e., dropped) or in part, such as to be able to observe but unable to contribute content while the communication continues between customer 210 and administrative agent 214.

FIG. 3 depicts system 300 in accordance with embodiments of the present disclosure. System 300 comprises portions of system 200 (see FIG. 2) except as noted. In one embodiment, system 300 utilizes automated agent 302 with data storage 304 as resource 112. Automated agent 302 may comprise processor executing machine-readable instructions maintained in a non-transitory memory of automated agent 302 or in data storage 304 or other non-transitory storage device. Additionally or alternatively, automated agent 302 may be co-embodied with server 202.

In one embodiment, automated agent 302 provides content in a communication to customer 210. Automated agent 302 may be or comprise an artificial intelligence or other logic that may select content in a manner that cannot be known with certainty in advance. For example, automated agent 302 may comprise a self-learning portion wherein prior communications, having an associated actual and expected emotion, are scored. The scoring may optionally be evaluated in response to a secondary metric (e.g., customer feedback, post-hoc review, success/failure rate for a communication to result in a desired outcome, etc.). As a result, a plurality of content may be obtained and maintained, such as in data storage 304. Automated agent 302 may be trained with favorable results (e.g., good feedback, successful outcome, etc.) and/or unfavorable results (e.g., negative feedback, unsuccessful outcomes, etc.) in order to train automated agent 302 to select a particular content that is more likely to be successful in a current or future communication having particular customer and/or subject matter attributes. More specifically, automated agent 302 attempts to provide the content that is best suited for a particular communication. Content that is acceptable, or even ideal, in one communication with a particular customer 210 and/or any fact-specific circumstances associated with the communication, may be less than ideal, or inappropriate, in a different communication with a different particular customer 210 and/or any fact-specific circumstances associated with the communication.

Automated agent 302 may attempt to learn the factors that matter and those that do not, and any associations between the factors, and base a selection decision on the factors that matter. For example, automated agent 302 may determine that past communications with a number of customers 210 were provided with varying content and the success or failure had a very low correlation with the particular customer communication device 108 utilized (e.g., brand of personal computer, operating system of a smart phone, etc.) and, therefore, the selection of a particular content, when based on device type, had no appreciable affect on the success of the communication. However, automated agent 302 may determine that the location of customer communication device 108, for the past communications did make a difference. For example, when a number of customer communication device 108 for a number of past communications, were located at an airport or train station, success was improved with content that emphasized brevity, even at the cost of the content being more cold or machine-like. Similarly, when a number of customer communication device 108, for a second number of past communications, were located at a home or business, success was improved with content that was more verbose. The factors that automated agent 302 learns from past communications and selects in a future communication may be difficult or impossible to ascertain in advance.

Variations in the factors detected and utilized may also be the result of randomness (or pseudo-randomness as is known in the computing arts) of a particular selection as a feature of automated agent 302. Ridged selection algorithm requires an ideal content be to be selected for a fixed set of factors known in advance. By utilizing artificial intelligence, factors previously unknown or not considered may be utilized or those believed to be irrelevant may be discounted or omitted. However, this requires an ability to vary the factors considered. Accordingly, in another embodiment, automated agent 302 attempts to determine the best content for a particular communication based on making variable selection decisions of the content. This may forego a current best content for an unknown, or previously identified less-optimal, in order to determine if the current best content is or is not in need of updating or replacing. By using a random or weighted random selection of content from a pool of content, automated agent 302 may better learn the factors relevant to a particular content selection and/or the specific content that is best suited to produce a successful result.

As an example, past communication with a number of customers 210 are maintained in data storage 304. Each communication has some factors that may have infrequent or no commonality (e.g., name of customer 210, date, time of day, etc.), such factors may be down-weighted as having little to no relevance. Other factors may be more relevant (e.g., expressed or perceived urgency, subject matter of the communication, past history with the customer, etc.) and up-weighted as being more or highly relevant. Factors being more relevant are selected for consideration more often than those considered less relevant. Similarly, associations with content provided during the past communications may be determined to be more or less relevant. For example, a large pool of past communications, such as those having a factor wherein the subject matter was “lost luggage,” had an overall success rate of 85%. If it is determined that of those, communications which were provided with content that was more authoritative had a success rate of, 84.7% (within a previously determined nominal range, such as one standard deviation) and communications that had less authoritative content had a success rate of 86.1%, then making a selection of more content based on authoritativeness is unlikely to affect the success of a current or future communication regarding lost luggage. Accordingly, selecting content based on the authoritative aspect of the content may be down-weighted or discounted entirely.

In contrast, if the past communications had content that was more empathetic had an overall success rate of 93% and those with low empathy content had a success rate of 23%, then selecting content based on empathy, and in particular high empathy, may be more likely to lead to the success of a current or future communication regarding lost luggage. Accordingly, selecting content based on the empathy aspect of the content may be up-weighted. As can be appreciated, the relevancy of one factor (e.g., when the subject matter is ‘lost luggage.’) may have relevant relationship to other factors (e.g., when the subject matter is ‘lost luggage’ and the current location is a home location versus a hotel). Accordingly, automated agent 302 may weigh the selection of a particular content so that the most likely successfully content is selected, but to also to discover factors that may be previously unknown or not considered that, once utilized to select a content, are more likely to improve the success of the communication.

In another embodiment, the weighting may be normalized such that the combination of all content is 100% and the chance that any one content is selected determined, in whole or in part, by a normalized weighting for that content. In another embodiment, randomization may be applied, in whole or in part, so that content that is sufficiently down-weighted as to not be selected, is at least occasionally selected so as to confirm, or if necessary, adjust the weighting.

In another embodiment, automated agent 302, especially when in the learning phase, may make select and deliver an actual content that is different from the expected content in terms of score (z) or one or more score factors (f(z)). This may be particularly pronounced when automated agent 302 does not yet have enough data to determine factors that are relevant or not relevant. As an example, automated agent 302 may conduct a successful communication with customer 210 with the name of “Alice,” wherein the random selection of content was made of content that was exceptionally high in “concern.” Automated agent 302 may then associate high “concern” context with customer's name of Alice. In a subsequent call, customer 210 also has the name of “Alice” but is a different individual. Automated agent 302, now has a weighting bias towards “concern” when the customer's name is “Alice.” However, an expected content may have low “concern,” such as when the subject matter is of minor consequence and overly high “concern” is likely to be perceived as condescending or patronizing. Due to the small sample size, automated agent 302 selects high “concern” context and delivers the message. Rather than solely waiting for a larger data size to down weight the association between “Alice(s)” and high “concern,” server 202 determines a difference (score ‘z’) between the actual and expected content and responds.

In one embodiment, such as when the value of z is low (e.g., within a previously determined nominal range), the action taken by server 202 may be limited to record keeping or other notifications. In other embodiments, such as when the value of z is high (e.g., outside a previously determined nominal range), the action taken by server 202 may be to format a message for presentation by administrative communication device 212 and/or initiate a transfer of the communication to a different node (e.g., agent communication device 206, administrative communication device 212, etc.), and/or provide feedback back to automated agent 302, such as to provide a data structure comprising the expected factor (e.g., “Expected ‘Concern=3’, Expected Empathy=5, etc.) and/or differences (e.g., deltas) between the actual and expected (e.g., “Concern delta=−3,” “Empathy delta=+0.3”, etc.). Accordingly, automated agent 302 may identify the context selected, and the inputs utilized into making such a selection, and the data structure providing the feedback and adjust the weighting of the inputs accordingly.

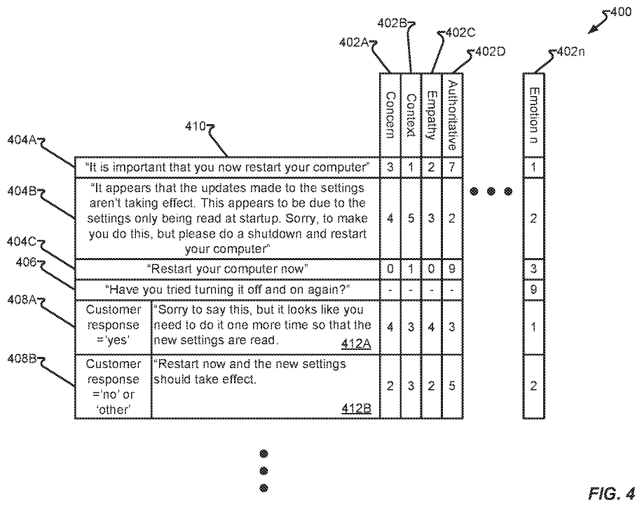

FIG. 4 depicts data structure 400 in accordance with embodiments of the present disclosure. In one embodiment, data structure 400 is maintained in a non-transitory data storage, such as data storage 204, data storage 304, and/or a non-transitory memory associated with server 202 and/or data storage 304. Data structure 400 comprises a number of records 404A-C, and/or 406 and 408A-B, comprising expected content field 410, such as may be provided as a prompt on agent communication device 206. Data structure 400 comprises a fields for number of emotional context scores 402, such as concern 402A, context 402B, empathy 402C, authoritative 402D and/or more, as illustrated by field 402n. It should be appreciated that more, fewer, or different emotional context scores may be selected from those illustrated.

In another embodiment, data structure 400 comprises records 404A-C, 406, and 408A-B. Records 404A-C comprise fields for content and associated score for emotional context scores 402. Records may be nested, such record 406 may omit one or more scores in emotional context scores 402 when designed to solicit a response, such as a particular one of record 408A (e.g., when a customer responds affirmatively) or record 408B (e.g., when a customer responds in the negative), and the particular record 408A or 408B selected having an associated emotional context scores 402. The particular record 408A or 408B selected then having its own expected content field 412A, 412B, respectively.

In another embodiment, factors of a particular communication with customer 210 may determine that a message having a context of “5” should be utilized. Accordingly, content field 410 of record 404B is selected and provided as a prompt to human agent 208 via agent communication device 206. Additionally or alternatively, if human agent 208 alters the message in some way the actual message delivered to customer communication device 108 may be scored, or factors thereof scored, and compared to factors provided in scores 402 for subsequent processing. Improvements may include adopting better than expected results for future use, formatting a standardized message for real time delivery to administrative communication device 212, automatically altering the topology of the network, etc.

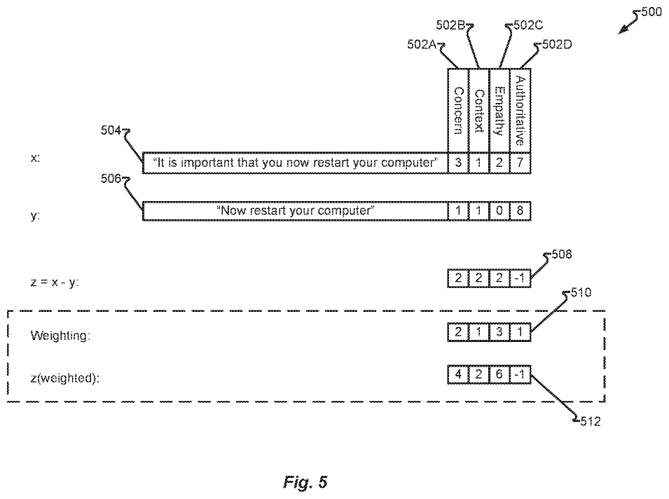

FIG. 5 depicts transition of data 500 in accordance with embodiments of the present disclosure. In one embodiment, transition of data 500 comprises record 504 indicating an expected content to be delivered to customer communication device 108. Scoring of record 504 is provided by scores 502 and produce an expected score x. The actual content is illustrated by record 506 having scores 502 and producing an expected score y (factors of y). The difference z, is illustrated as scores 508. Differences, in absolute value or signed, may be noted and responded to as described herein. As a further option, scoring may be weighted, such as by weighing values 510 for one or more scores 508 to produce a weighted score 512. Weighting may be provided as reflective of importance or in proportion to past successes for ones of score 502.

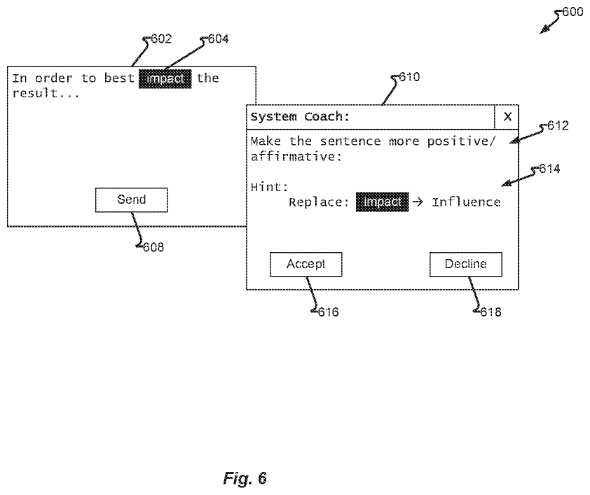

FIG. 6 depicts display 600 in accordance with embodiments of the present disclosure. In one embodiment, agent communication device 206 comprises display 600. Dialog 602 illustrates a content of communication portion that is in progress with customer communication device 108 and customer 210, but the communication portion has not yet been sent. Accordingly, a processor, such as a processor of agent communication device 206 and/or server 202 receives the content of dialog 602 in real time as it is being typed and performs a scoring of the text, also in real time. For example, the content of dialog 602 may include word 604 that causes dialog 602 to be skewed to an undesirable score, such as in the scoring factor associated with positive or affirmative statements, Accordingly, dialog 610 may pop-up or otherwise be presented comprising one or more of hint 612, to indicate the factor that is determined to be unfavorable for dialog 602, and/or suggestion 614 as a specific replacement that, if accepted by selecting accept option 616, would replace word 604 with the suggested word and cause the score of dialog 602 to be favorable or at least more favorable. If the agent choses to decline, by selection decline option 618, dialog 610 close and the agent may override the decision by completing dialog 602 and selecting send 608.

In another embodiment, suggestion 614 and statistics regarding whether the suggestion was accepted or declined may be utilized to select alternate suggestions, such as when a particular suggestion has very low acceptance and a different term is utilized for suggestion 614 which has a greater rate of acceptance. Additionally or alternatively, acceptance/decline statistics for a particular suggestion 614 may be utilized as an input into automated agent 302 to more rapidly train automated agent 302 as to what issues may occur when word 604 are encountered and which suggestions more likely to be accepted by a human agent.

While display 600 is illustrated as conducting a portion of a text-based communication, it should be appreciated that similar content, presented differently, may be utilized for different communication forms. For example, human agent 208 spoke the word 604 in dialog 602 during an audio or audio-video communication, dialog 610 may provide a text-based reminder to use a different word in the future. Additionally or alternatively, the reminder may be presented as a “whisper” communication into the audio received by human agent 208, but not customer 210.

Dialog 610 may be presented as the result of a standardized message received from one of a number of inputs (e.g., a score, a score factor, a cumulative score over time/plurality of agents, magnitude of the score, etc.) and presented in real time to human agent 208 via agent communication device 206 and, optionally administrative communication device 212, and any automated monitoring agents currently being utilized. As a result, each receiver may receive a standardized message from non-standard inputs in real time as the substandard or non-nominal score is encountered.

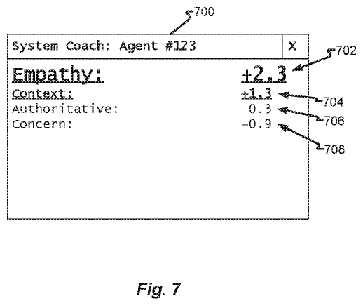

FIG. 7 depicts display 700 in accordance with embodiments of the present disclosure. In one embodiment, display 700 comprises all or a portion of a visual output display of agent communication device 206, administrative communication device 212, and/or any other monitoring devices similarly configured. In response to receiving a message regarding a particular content being outside of a nominal range or otherwise determined to require action. The real time message may be received for presentation by display 700.

In addition to presenting the content of the message, display 700 may present a secondary indicia of the content of the message. For example, line 702 has a value that is well outside a nominal range (e.g., greater than two standard deviations, greater than a previously determined value, etc.) and, as such, is presented with formatting that includes bolding, underlining, and a larger font, as well as the value that caused the particular formatting. Line 704 is also outside a nominal range but less so (e.g., greater than one standard deviation, greater than a previously determined value, etc.) and a different formatting selected (e.g., bolding and underlined, but with a standard font size, as well as the value that determined the formatting. Lines 706 and 708 illustrate values that are determined to be within a nominal range (e.g., less than one standard deviations, less than a previously determined value, etc.) and are presented with default formatting as well as the value that determined the formatting.

As a benefit, values of scores may be presented to one or more devices for viewing in a manner that not only displays the value but displays the metric and associated value in a manner determined in real time based on the value. It should be appreciated that this paper can only accommodate illustrations in black and white, but the use of color as a formatting option, such as green for nominal, or a previously determined value, and yellow, orange, red, etc. for progressively increasing distance from the nominal range or previously determined value. As a further embodiment, display 700 may be updated in real time or historic value for one or more agents and/or over a particular period of time or purpose.

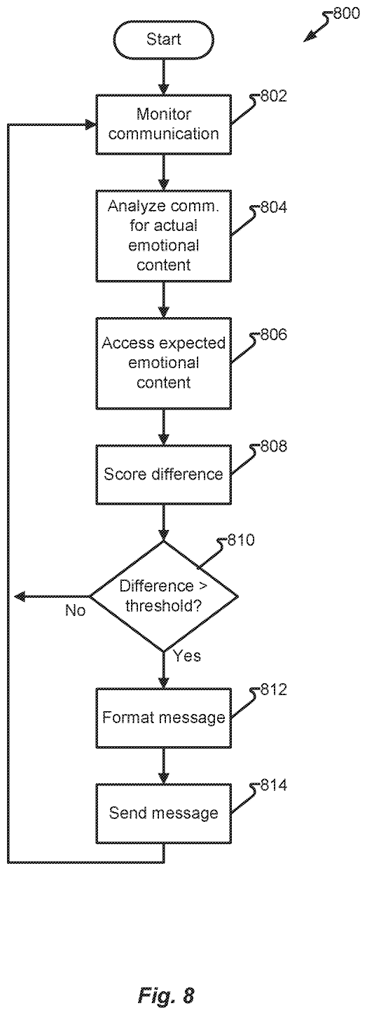

FIG. 8 depicts process 800 in accordance with embodiments of the present disclosure. In one embodiment, process 800 may be embodied as machine-readable instructions maintained in a non-transitory storage, such as a memory associated with server 202, automated agent 302, and/or agent communication device 206, storage 204, data storage 304 that cause a processor to execute the machine-readable instructions to carry out process 800.

In one embodiment, process 800 begins and monitors a communication between resource 112 and customer 210 utilizing customer communication device 108. Resource 112 may be agent communication device 206 operated by human agent 208 or automated agent 302. The communication may be monitored in real time or, such as in the case of monitoring textual messages as they are typed, monitored before transmission. Step 804 analyzes the communication, or portions of the communication, for the actual emotional content therein. It should be appreciated that other means may be utilized for monitoring the factual content (e.g., determining whether a communication or message of a communication provides a required answer, question, instruction, or other factual content necessary to resolve the reason for the communication) independently of the emotional content described herein.

Step 806 accesses, such as from data storage 204 and/or data storage 304, an expected emotional content. The expected emotional content may be based on the factors described herein, such as an attribute of customer 210, subject matter of the communication, etc. Step 808 scores the difference and/or factors of the difference. Test 810 determines if the difference is greater than a threshold value, such as more or outside of a nominal range of scores. If test 810 is determined in the negative, process 800 may loop back to step 802 to continue monitoring the communication until such time as process 800 ends upon the termination of the communication.

If test 810 is determined in the affirmative, step 812 formats a standardized message and sends the message in step 814. Step 814 may be performed in real time, such as when the communication is still ongoing or for a historical or aggregate trend over time and/or agents. Process 800 may then continue back to step 802 until such time as the communication ends. While illustrated as discrete steps, the steps of process 800 may not end upon the imitation of the subsequent step so as to provide ongoing and real time monitoring of a communication, and the content as it occurs, and response messages thereto.

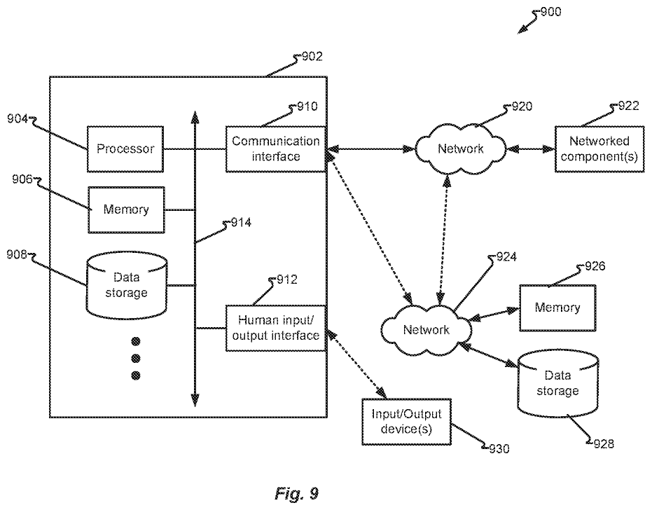

FIG. 9 depicts system 900 in accordance with embodiments of the present disclosure. In one embodiment, agent communication device 206, administrative communication device 212 and/or automated agent 302 may be embodied, in whole or in part, as device 902 comprising various components and connections to other components and/or systems. The components are variously embodied and may comprise processor 904. Processor 904 may be embodied as a single electronic microprocessor or multiprocessor device (e.g., multicore) having therein components such as control unit(s), input/output unit(s), arithmetic logic unit(s), register(s), primary memory, and/or other components that access information (e.g., data, instructions, etc.), such as received via bus 914, executes instructions, and outputs data, again such as via bus 914. In other embodiments, processor 904 may comprise a shared processing device that may be utilized by other processes and/or process owners, such as in a processing array or distributed processing system (e.g., “cloud”, farm, etc.). It should be appreciated that processor 904 is a non-transitory computing device (e.g., electronic machine comprising circuitry and connections to communicate with other components and devices). Processor 904 may operate a virtual processor, such as to process machine instructions not native to the processor (e.g., translate the Intel® 9xx chipset code to emulate a different processor's chipset or a non-native operating system, such as a VAX operating system on a Mac), however, such virtual processors are applications executed by the underlying processor (e.g., processor 904) and the hardware and other circuitry thereof.

In addition to the components of processor 904, device 902 may utilize memory 906 and/or data storage 908 for the storage of accessible data, such as instructions, values, etc. Communication interface 910 facilitates communication with components, such as processor 904 via bus 914 with components not accessible via bus 914. Communication interface 910 may be embodied as a network port, card, cable, or other configured hardware device. Additionally or alternatively, human input/output interface 912 connects to one or more interface components to receive and/or present information (e.g., instructions, data, values, etc.) to and/or from a human and/or electronic device. Examples of input/output devices 930 that may be connected to input/output interface include, but are not limited to, keyboard, mouse, trackball, printers, displays, sensor, switch, relay, etc. In another embodiment, communication interface 910 may comprise, or be comprised by, human input/output interface 912. Communication interface 910 may be configured to communicate directly with a networked component or utilize one or more networks, such as network 920 and/or network 924.

Rc104 may be embodied, in whole or in part, as network 920. Network 920 may be a wired network (e.g., Ethernet), wireless (e.g., WiFi, Bluetooth, cellular, etc.) network, or combination thereof and enable device 902 to communicate with network component(s) 922. In other embodiments, network 920 may be embodied, in whole or in part, as a telephony network (e.g., public switched telephone network (PSTN), private branch exchange (PBX), cellular telephony network, etc.)

Additionally or alternatively, one or more other networks may be utilized. For example, network 924 may represent a second network, which may facilitate communication with components utilized by device 902. For example, network 924 may be an internal network to a business entity or other organization, such as contact center 102, whereby components are trusted (or at least more so) that networked components 922, which may be connected to network 920 comprising a public network (e.g., Internet) that may not be as trusted.

Components attached to network 924 may include memory 926, data storage 928, input/output device(s) 930, and/or other components that may be accessible to processor 904. For example, memory 926 and/or data storage 928 may supplement or supplant memory 906 and/or data storage 908 entirely or for a particular task or purpose. For example, memory 926 and/or data storage 928 may be an external data repository (e.g., server farm, array, “cloud,” etc.) and allow device 902, and/or other devices, to access data thereon. Similarly, input/output device(s) 930 may be accessed by processor 904 via human input/output interface 912 and/or via communication interface 910 either directly, via network 924, via network 920 alone (not shown), or via networks 924 and 920. Each of memory 906, data storage 908, memory 926, data storage 928 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 930 may be a router, switch, port, or other communication component such that a particular output of processor 904 enables (or disables) input/output device 930, which may be associated with network 920 and/or network 924, to allow (or disallow) communications between two or more nodes on network 920 and/or network 924. For example, a connection between one particular customer, using a particular customer communication device 108, may be enabled (or disabled) with a particular networked component 922 and/or particular resource 112. Similarly, one particular networked component 922 and/or resource 112 may be enabled (or disabled) from communicating with a particular other networked component 922 and/or resource 112, including, in certain embodiments, device 902 or vice versa. Ones of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJS™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method for responding to a non-compliant action, comprising:
monitoring content of a communication between an agent communication device utilized by an agent and a customer communication device utilized by a customer, respectively;
analyzing the content for emotion to produce an actual emotional content;
accessing an expected emotional content associated with the communication;
producing a score as the difference between the target emotional content and the observed emotional content;
formatting a message to comprise the score; and
transmitting the message in real time to at least one device, selected from the agent communication device and an administrative communication device, to cause the at least one device to have immediate access to the score.

2. The method of claim 1, wherein the formatting of the message to comprise the score and the transmitting of the message in real time to the at least one device, are performed upon determining the score is outside a nominal range.

3. The method of claim 1, further comprising:
adding the score to a data structure maintained in a data storage device;
deriving, from the data structure, an aggregate score for a plurality of scores, comprising the score, for at least one of (i) an associated first plurality of communications each of which comprises content provided by the agent or (ii) an associated second plurality of communications each of which comprises content provided by a plurality of agents, comprising the agent;
formatting an aggregate score message to comprise the aggregate score; and
transmitting the aggregate score message in real time to the at least one device to cause the at least one device to have immediate access to the aggregate score.

4. The method of claim 1, wherein:
formatting the message comprising the score, further comprises, formatting the message to comprise the score and at least one secondary indicia of the magnitude of the score; and
transmitting the message in real time to the at least one device, selected from the agent communication device and the administrative communication device, to cause the at least one device to have immediate access to the score and the secondary indicia of the magnitude of the score.

5. The method of claim 1, wherein the score comprises at least one score factor, as the difference between a target factor for the content and the observed factor, and comprising a value for one or more of word selection from a pool of words that differ in emotional association, phrase selection from a pool of phrases that differ in emotional association facial expression, punctuation selection from a pool of punctuations that differ in emotional association, graphic selection from a pool of graphics that differ in emotional association, body posture, gesture, paralinguistic, eye gaze, and delivery timing of messages comprising the communication.

6. The method of claim 1, wherein formatting the message to comprise the score, further comprises formatting the message to comprise indicia of the score.

7. The method of claim 1, wherein the communication comprises a text-based communication message maintained in the agent communication device as a draft and wherein the transmitting of the message is pending.

8. The method of claim 1, wherein:
the agent comprises an automated agent selecting content from a data storage comprising a plurality of content and each having a weighting value determining, in part, a past score as the difference between the target emotional content and the observed emotional content of a past communication comprising each of the plurality of content; and
the selection of the content comprises a pseudo-random weighted selection from the plurality of content.

9. The method of claim 8, further comprising updating the past score to comprise the score for the content selected.

10. A system for responding to a non-compliant action, comprising:
a processor coupled to a non-transitory memory comprising executable instructions;
a network interface coupled to the processor; and
wherein the instructions cause the processor to:
monitor content of a communication between an agent communication device utilized by an agent and a customer communication device utilized by a customer, respectively;
analyze the content for emotion to produce an actual emotional content;
access an expected emotional content associated with the communication;
produce a score as the difference between the target emotional content and the observed emotional content;
format a message to comprise the score; and
transmit the message in real time to at least one device, selected from the agent communication device and an administrative communication device, to cause the at least one device to have immediate access to the score.

11. The system of claim 10, wherein the instructions further cause the processor to format the message to comprise the score and the transmitting of the message in real time to the at least one device, are performed following executing instructions to cause the processor to determine the score is outside a nominal range.

12. The system of claim 10, wherein the instructions further cause the processor to:
add the score to a data structure maintained in a non-transitory data storage device;
derive, from the data structure, an aggregate score for a plurality of scores, comprising the score, for at least one of (i) an associated first plurality of communications each of which comprises content provided by the agent or (ii) an associated second plurality of communications each of which comprises content provided by a plurality of agents, comprising the agent;
format an aggregate score message to comprise the aggregate score; and
transmit the aggregate score message in real time to the at least one device to cause the at least one device to have immediate access to the aggregate score.

13. The system of claim 10, wherein the instructions further cause the processor to:
format the message comprising the score, further comprise instructions to cause the processor to format the message to comprise the score and at least one secondary indicia of the magnitude of the score; and
transmit the message in real time to the at least one device, to cause the at least one device to have immediate access to the score and the secondary indicia of the magnitude of the score.

14. The system of claim 10, wherein the score comprises at least one score factor, as the difference between a target factor for the content and the observed factor, and comprising a value for one or more of word selection from a pool of words that differ in emotional association, phrase selection from a pool of phrases that differ in emotional association facial expression, punctuation selection from a pool of punctuations that differ in emotional association, graphic selection from a pool of graphics that differ in emotional association, body posture, gesture, paralinguistic, eye gaze, and delivery timing of messages comprising the communication.

15. The system of claim 10, wherein the instructions that cause the processor to format the message to comprise the score, further comprise instructions to cause the processor to format the message to comprise indicia of the score.

16. The system of claim 10, wherein the communication comprises a text-based communication message maintained in the agent communication device as a draft and wherein the instructions to cause the processor to transmit the message have not been executed.

17. The system of claim 10, wherein:
the agent comprises an automated agent selecting content from a data storage comprising a plurality of content and each having a weighting value determining, in part, a past score as the difference between the target emotional content and the observed emotional content of a past communication comprising each of the plurality of content; and
wherein the instructions to cause the processor to select the content further comprises instructions to cause the processor to make a pseudo-random weighted selection from the plurality of content.

18. The system of claim 17, wherein the instructions further comprise instructions to cause the processor to update the past score to comprise the score for the content selected.

19. A system for responding to a non-compliant action, comprising:
means to monitor content of a communication between an agent communication device utilized by an agent and a customer communication device utilized by a customer, respectively;
means to analyze the content for emotion to produce an actual emotional content;
means to access an expected emotional content associated with the communication;
means to produce a score as the difference between the target emotional content and the observed emotional content;
means to format a message to comprise the score; and
means to transmit the message in real time to at least one device, selected from the agent communication device and an administrative communication device, to cause the at least one device to have immediate access to the score.

20. The system of claim 19, further comprising:
means to determine whether the score is outside a nominal range; and
means to omit the means to format the message to comprise the score and the means to transmit the message in real time to the at least one device, when the score is within the nominal range.
